(19) United States
(12) Patent Application Publication
(10) Pub. No.: US 2007/0206135 A1
(43) Pub. Date: Sep. 6, 2007

(54) Liquid crystal display element

(75) Inventors: Masumi Manabe, Fukaya-shi (JP); Atsuyuki Manabe, Fukaya-shi (JP); Kisako Ninomiya, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA MATSUSHITA DISPLAY TECHNOLOGY CO., LTD.

(21) Appl. No.: 11/712,411

(22) Filed: Mar. 1, 2007

(30) Foreign Application Priority Data
Mar. 3, 2006 (JP) 2006-058479

(51) Int. Cl. G02F 1/1335

(52) U.S. Cl. 349/106

(57) ABSTRACT

Island-shaped portions of colored layers each of which constitutes a part of a sub pixel are formed so as to be continuous with each other over the gap between adjacent pixels. The area of the island-shaped portion can be secured even when the size of the pixel is reduced to enhance the fineness, and peeling of the island-shaped portions at the formation time of a color filter layer which occurs in connection with miniaturization of the island-shaped portions can be suppressed, so that the yield can be improved while enhancing the display quality.

### INCORPORATION BY REFERENCE

The Present application claims priority under 35 U.S.C. §119 to Japanese Patent Application No. 2006-058479 filed on Mar. 3, 2006. The content of the application is incorporated herein by its entirety.

### FIELD OF THE INVENTION

The present invention relates to a liquid crystal display element including pixels arranged in a matrix form, each of the pixels having a plurality of sub pixels corresponding to plural kinds of different colors.

### BACKGROUND OF THE INVENTION

In general, a liquid crystal display element has the construction that a liquid crystal layer is sandwiched between two glass substrates having electrodes, the surrounding of the two substrates is fixed by adhesive agent except for a liquid crystal filling port, and the liquid crystal filling port is sealed by sealing agent. Plastic beads having a uniform particle diameter are dispersed as spacers for keeping the distance between the glass substrates constant between the two glass substrates.

In these liquid crystal display elements, for example, in a liquid crystal display element for color display, a color filter having colored layers of RGB is provided to any one of the two glass substrates.

For example, a simple matrix driving type color dot matrix liquid crystal display element is designed so that a Y substrate having Y electrodes patterned in a striped shape in the lateral (Y) direction and an X substrate having a colored layer below X electrodes patterned in a striped shape in the vertical (X) direction are arranged so as to face each other so that the Y electrode and the X electrode are substantially arranged perpendicular to each other, and liquid crystal composition material is sandwiched between these substrates.

In the liquid crystal display device for color display, a color filter layer composed of a red color layer colored with R (red), a green color layer colored with G (Green) and a blue color layer colored with B (Blue) is formed on any one glass substrate of an array substrate and a counter substrate. As a display system of the liquid crystal display device used is a TN (Twisted Nematic) type, ST (Stock Time) type, GH (Guest Host) type or ECB (Electrically Controlled Birefringence) type, or ferromagnetic liquid crystal, for example. As the sealing agent used is an acrylic type or epoxy type adhesive agent of a thermosetting type which is cured by heat, an ultraviolet curable type which is cured by irradiation of ultraviolet rays or the like.

On the other hand, the color type active matrix driving liquid crystal display element is composed of a TFT array substrate as an active matrix substrate equipped with thin film transistors that have amorphous silicon (a-Si) as semiconductor layers (TFT) and arranged in a matrix form, and display electrodes, signal line electrodes and gate electrodes which are electrically connected to the thin film transistors, and a counter substrate disposed so as to face the TFT array substrate, wherein an RGB color filter is formed on the counter substrate, silver paste achieved by pasting electrically conductive silver particles as electrode transfer material (transfer) for applying a voltage from the TFT array substrate to the counter substrate with binder or the like is disposed at the peripheral portion of the screen, the TFT array substrate and the counter substrate are electrically connected to each other by the electrode transfer material, and further liquid crystal composition material is sandwiched between these substrates. Polarization plates are disposed at both the sides of these substrates as an optical shutter, whereby a color image can be displayed.

In a liquid crystal display device for AV such as TV pictures or the like, in order to bring an image with smoothness from the necessity of representing a person with moving pictures, it is said that a delta arrangement or a slant mosaic arrangement is suitable as the arrangement of the RGB color filter as disclosed in Japanese Laid-open Patent Publication No. 2004-246190 or Japanese Laid-open Patent Publication No. 2001-281649, for example. Furthermore, when much attention is focused on reproducibility of the image, high resolution and color reproducibility are important.

For example, when the delta arrangement or the mosaic arrangement is used, the color filter of each color is frequently formed in an island-shape (island-shape). However, when the fineness is enhanced, the area of each color per pixel is lowered. When a colored layer is formed with high precision, it is preferably formed by photolithography using pigment resist. However, when a pattern is formed at a small area in an island-shape, there is a problem that the pattern is easily peeled. The easiness in peeling is also affected by the shape of the pattern. For example, when the shape of a pattern is set to a triangular shape containing an acute angle, the acute portion is particularly easily peeled.

Furthermore, importance is attached to color reproducibility, four colors are more preferable than three colors for the colored layer (EURODISPLAY2002, P. 827-830). However, if the colored layer is set to four colors, the area of the colored layer per color is further reduced, and thus the problem of the easiness in peeling described above occurs more easily.

Furthermore, in order to enhance the reproducibility of the image, it is important that the gap of the display element is made uniform.

When plastic beads are dispersed as spacers on the substrate in the manufacturing process, the spacers serve as particles polluting the manufacturing line. Therefore, not only do the spacers cause defectives, but also the spacers existing at the pixel portion cause degradation of the image quality due to orientation failure, and further gap failure is easily induced by aggregating spacer agglomerates or non-uniformity of the dispersion density.

As a technique for taking countermeasures to the above problem, for example, Japanese Laid-Open Patent Publication No. 2005-62589 has proposed that pillar-shaped spacers are provided on the substrate. Furthermore, as described in Japanese Laid-Open Patent Publication No. 2005-258328, the number of steps can be reduced by forming these spacers of the same material as a frame portion light shielding layer.

In these liquid crystal display elements, it is preferable that the arrangement position of the pillar-shaped spacers are disposed at steps between colors so that they do not influence the display. However, in this case, when the spacers are arranged between different colors, there occurs a problem that the shape of the pillar-shaped spacers is deformed or the height of the spacers is varied due to the effect of the step between the colored layers of the base.

As a result, the above liquid crystal display element has a problem that the yield is reduced because the colored layer is peeled when the fineness is enhanced or the like, and also the image reproducibility is lowered due to the arrangement of the pillar-shaped spacers.

The present invention has been implemented in view of the foregoing points, and has an object to provide a liquid crystal display element that improves the yield while enhancing the display quality.

### SUMMARY OF THE INVENTION

According to the present invention, a liquid crystal display element including an array substrate, a counter substrate disposed so as to face the array substrate, and a liquid crystal layer interposed between the array substrate and the counter substrate, pixels each of which has a plurality of sub pixels corresponding to plural kinds of different colors are formed in a matrix form, wherein each sub pixel has a colored layer provided between the array substrate and the counter substrate corresponding to each color, the respective colored layers are formed in an island-shape and at least some of the colored layers are continuous with one another over the gap between the adjacent pixels. The colored layers of the plurality of sub pixels of the pixels are formed in an island-shape so as to be continuous with each other over the gap between the adjacent pixels, whereby the area of the island-shaped colored layer can be secured even when the size of the pixels is reduced, and occurrence of peeling when the colored layer is formed can be suppressed, so that the yield can be improved while enhancing the display quality.

### BRIEF DESCRIPTION OF THE DRAWINGS

FIG. 1 is a plan view showing a main part of a liquid crystal display element according to a first embodiment of the present invention,

FIG. 2 is a longitudinally-sectional view showing a liquid crystal display device provided with the liquid crystal display element,

FIG. 3 is a longitudinally-sectional view showing a main part of the liquid crystal display element according to a second embodiment of the present invention,

FIG. 4 is a plan view showing a main part of the liquid crystal display element according to a third embodiment of the present invention,

FIG. 5 is a longitudinally-sectional view showing a main part of the liquid crystal display device provided with the liquid crystal display element,

FIG. 6 is a longitudinally-sectional view showing a main part of the liquid crystal display device provided with a liquid crystal display element according to a fourth embodiment of the present invention,

FIG. 7 is a longitudinally-sectional view showing a main part of the liquid crystal display device provided with a liquid crystal display element according to a fifth embodiment of the present invention,

FIG. 8 is a plan view showing a main part of the liquid crystal display element according to a sixth embodiment of the present invention,

FIG. 9 is a plan view showing a main part of the liquid crystal display element according to a seventh embodiment of the present invention,

FIG. 10 is a plan view showing a conventional example of the liquid crystal display element,

FIG. 11 is a plan view showing a main part of the liquid crystal display element according to an eighth embodiment of the present invention,

FIG. 12 is a plan view showing a conventional example of the liquid crystal display element,

FIG. 13 is a plan view showing a main part of the liquid crystal display element according to a ninth embodiment of the present invention,

FIG. 14 is a plan view showing a main part of the liquid crystal display element according to a tenth embodiment of the present invention,

FIG. 15 is plan view showing a main part of the liquid crystal display element according to an eleventh embodiment of the present invention,

FIG. 16 is a plan view showing the liquid crystal display element,

FIG. 17 is a plan view showing a main part of the liquid crystal display element according to a twelfth embodiment of the present invention, and

FIG. 18 is a plan view showing a main part of the liquid crystal display element according to a thirteenth embodiment of the present invention.

### DETAILED DESCRIPTION OF THE PREFERRED EMBODIMENT

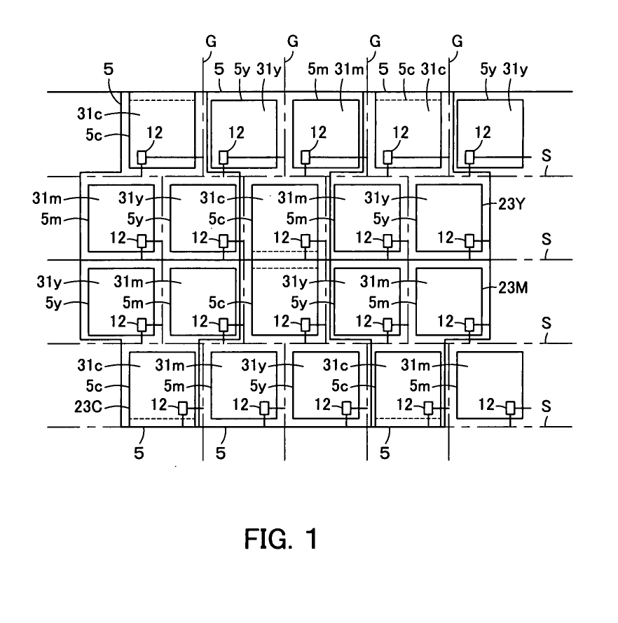

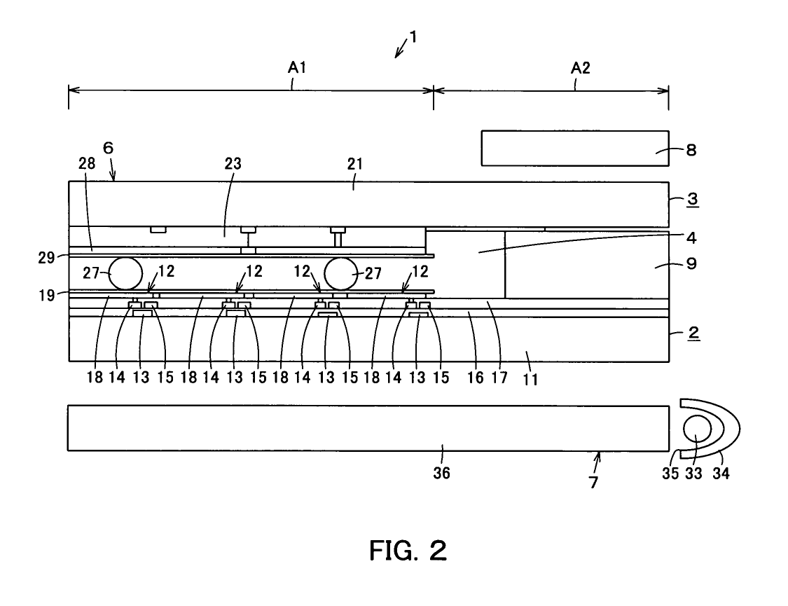

The construction of a liquid crystal display element according to a first embodiment of the present invention will be described with reference to FIGS. 1 and 2.

FIG. 2 shows a liquid crystal display device 1. The liquid crystal display device 1 is a TN driving type color liquid crystal display device including, an active matrix substrate 6 as a liquid crystal display element in which an array substrate 2 and a counter substrate 3 are disposed so as to face each other, and a liquid crystal layer 4 is interposed between these substrates 2 and 3, and pixels 5 each including sub pixels 5c, 5m, and 5y are formed in a matrix form, and a backlight 7 as a planar light source device disposed at the back surface side of the active matrix substrate 6, that is, at the array substrate 2 side, wherein the active matrix substrate 6 and the backlight 7 are held between a frame (not shown) and a bezel 8 engagedly fitted to the frame. In the active matrix substrate 6 are formed a rectangular display area A1 located at the center portion and a frame-shaped non-display area A2 located along the peripheral edge portion of the display area A1.

The peripheral edge portion between the respective substrates 2 and 3 is provided with an adhesive agent layer 9 except for a filling port (not shown) for filling liquid crystal material, and the filling port is sealed by sealing agent such as ultraviolet curable resin. Furthermore, polarization plates (not shown) are attached to both the surfaces of the liquid crystal display device 1.

The array substrate 2 has a glass substrate 11 which is a transparent substrate as an insulating substrate, for example, and thin film transistors (TFT) 12 as a plurality of switching elements are formed in a matrix form on the glass substrate 11 in connection with the sub pixels 5c, 5m, and 5y of the pixels 5.

Here, the thin film transistor 12 has a gate electrode 13 formed of a scan line, that is, a part of the gate line G, a source electrode 14 formed of a part of the signal line S and a drain electrode 15. The gate electrode 13 is covered by a gate insulating film 16, and the source electrode 14 and the drain electrode 15 are disposed on the gate insulating film 16. The source electrode 14 and the drain electrode 15 are covered by an inter-layer insulating film 17 as a passivation film.

Each thin film transistor 12 is disposed at the intersecting point between the gate line G and the signal line S, and electrically connected to these gate line G and signal line S and a pixel electrode 18 formed on the inter-layer insulating film 17, whereby a voltage can be selectively applied to desired pixel electrodes 18.

Here, the pixel electrode 18 has sub pixel electrodes (not shown) corresponding to the sub pixels 5c, 5m, and 5y, and it is formed of transparent conductive material such as ITO (Indium Tin Oxide) or the like by the sputtering method. Furthermore, an orientation film 19 is formed on the pixel electrode 18. The orientation film 19 is formed by subjecting a thin film of transparent resin such as polyimide or the like to an orientation treatment through a rubbing treatment or the like.

The inter-layer insulating film 17 is formed of photosensitive resin or the like, and a contact hole (not shown) is formed in the inter-layer insulating film 17, so that the drain electrode 15 of the thin film transistor 12 and the pixel electrode 18 are electrically connected to each other via the contact hole.

The counter substrate 3 has a glass substrate 21 which is a transparent substrate as an insulating substrate, for example. A color filter layer 23, a black matrix (not shown) as a light shielding layer and a peripheral edge light shielding layer are formed at the position corresponding to the thin film transistor 12 of the array substrate 2 on the glass substrate 21, and further spacers 27 that are formed of spherical members such as plastic beads or the like and keep the spacing between the array substrate 2 and the counter substrate 3 are formed on the glass substrate 21. A common electrode 28 constituting the pixel 5 and an orientation film 29 are successively laminated on the color filter layer 23.

Here, as shown in FIG. 1, the sub pixels 5c, 5m, and 5y of each pixel 5 correspond to cyan (c), magenta (M) and yellow (Y) respectively, and they are disposed in a so-called delta arrangement (triangular arrangement). That is, the sub pixels 5c and 5m and 5y are located at the apexes of the triangle, and the adjacent sub pixels in the up-and-down direction of FIG. 1, that is, in the vertical scan direction arranged so as to be displaced from each other in the right-and-left direction of FIG. 1, that is, in the horizontal scan direction, thereby constituting the pixel 5 having a substantially convex shape. In this embodiment, in the pixel 5, the sub pixel 5c is located at the tip portion of the convex-shaped pixel 5, and the sub pixels 5m and 5y are located at the base end portions so as to be adjacent to each other in the right-and-left direction. The pixels 5 which are adjacent to each other in the right-and-left direction and the up-and-down direction of FIG. 1 are arranged in a state that they are mutually rotated by 180°, that is, they are reversed in the up-and-down direction and the right-and-left direction. In other words, the pixels 5 are arranged in the right-and-left direction and the up-and-down direction so as to be alternately reversed in the up-and-down direction.

The color filter layer 23 corresponds to the sub pixel electrode of the pixel electrode 18, and it is constructed by colored layers 23C, 23M, and 23Y serving as parts of the sub pixels 5c and 5m, and 5u.

Each of these colored layers 23C, 23M, and 23Y is formed of a mixture material containing photosensitive resin and colored pigment or colored dye corresponding to each color. Furthermore, these colored layers 23C, 23M, and 23Y include a plurality of island-shaped portions 31c, 31m, and 31y designed in a rectangular island-shape (island-shaped), and these island-shaped portions 31c and 31m, and 31y are disposed in the delta arrangement in connection with the sub pixels 5c, 5m, and 5y. In this embodiment, the island-shaped portions 31c are formed so as to be continuous with each other over the gap between the adjacent pixels 5 and 5 in the up-and-down direction of FIG. 1 on the sub pixels 5c and 5c. That is, each island-shaped portion 31c has about a double length of the island-shaped portions 31m and 31y in the longitudinal direction, and has about a double area of the island-shaped portions 31m and 31y. The colored layers 23C, 23M, and 23Y are formed so as to be substantially equal to one another in area.

Furthermore, the black matrix is formed so as to cover the wires such as the gate lines G, the signal lines S, etc. of the array substrate 2. Furthermore, the peripheral edge light shielding layer is also called a frame layer or the like, and it is formed at the peripheral edge portion of the screen. The black matrix and the peripheral edge light shielding layer are formed by using a mixture material of black pigment such as carbon fine particles or a mixture of black dye and photosensitive resin, and it is designed to shield leakage light.

As in the case of the pixel electrode 18 of the array substrate 2, the common electrode 28 is formed of transparent conductive material such as ITO (Indium Tin Oxide) or the like by the sputtering method or the like.

As in the case of the orientation film 19 of the array substrate 2, the orientation film 29 is formed by subjecting a thin film of transparent resin such as polyimide or the like to an orientation treatment through a rubbing treatment or the like, and in the active matrix substrate 6, the rubbing direction is displaced from the orientation film 19 by 90°.

The backlight 7 has a light source portion in which a lamp 33 as a light source is covered by a lamp reflector 34 for reflecting light from the lamp 33. The light source portion is disposed so that the opening 35 side of the lamp reflector 34 faces the side of an optical waveguide 36. The light from the lamp 33 is guided to the active matrix substrate 6 side by the optical waveguide 36.

Next, the method of manufacturing the active matrix substrate according to the first embodiment will be described.

First, as in the case of the process of forming normal thin film transistors, for example, a plate glass of 0.7 mm in thickness is used as the glass substrate 11, film formation and patterning are repeated on the plate glass to form the thin film transistors 12 of amorphous silicon, the wires such as the signal lines S, the gate lines G, etc., and a predetermined passivation pattern, that is, an inter-layer insulating film pattern and a pixel electrode pattern, thereby forming the array substrate 2.

Next, a plate glass of 0.7 mm in thickness is used as the glass substrate 21, the film formation and the patterning are repeated on the plate glass, the black matrix, and the peripheral light shielding layer are formed, and ITO is formed by the sputtering method, and then a predetermined common electrode pattern is formed, thereby forming the counter substrate 3.

Thereafter, the orientation film material is coated at a thickness of 500 Å on the overall principal surface of each of the array substrate 2 and the counter substrate 3, and then subjected to the rubbing treatment to form the orientation films 19 and 29.

Furthermore, the adhesive agent layer 9 is printed along the periphery of the orientation film 29 of the counter substrate 3 except for the filling port, and the electrode transfer material (transfer) for applying a voltage from the array substrate 2 side to the counter substrate 3 side is formed on the electrode transfer electrode on the periphery of the adhesive agent layer 9.

Furthermore, the array substrate 2 and the counter substrate 3 are disposed so that the orientation films 19 and 29 face each other and the rubbing directions thereof cross each other by 90° in a state that spherical spacers 27 such as plastic beads or the like are dispersed on the substrates 2 and 3, and then the adhesive agent layer 9 is cured by heating, whereby the array substrate 2 and the counter substrate 3 are attached to each other.

The liquid crystal composition of the liquid crystal layer 4 is filled from the filling port, and then the filling port is sealed by ultraviolet curable resin, thereby completing the active matrix substrate 6.

As described above, in the above first embodiment, the island-shaped portions 31c of the colored layers 23C having the same color are continuous with each other over the gap between the adjacent pixels 5 and 5.

That is, in order to bring images with smoothness so that the active matrix substrate 6 is made suitable for AV, the sub pixels 5c, 5m, and 5y are disposed in the delta arrangement, and furthermore, the fineness is improved to enhance the reproducibility of the image. Accordingly, even when the size of the sub pixels 5c, 5m, and 5y per pixel is reduced and thus the area is reduced, the area of the island-shaped portions 31c can be secured by making the island-shaped portions 31c continuous with each other over the gap between the pixels 5 and 5. Therefore, the island-shaped portions 31c can be suppressed from being peeled at the time of formation of the color filter layer 23, which would occur in connection with miniaturization of the island-shaped portions 31c, so that the yield can be improved while enhancing the display quality.

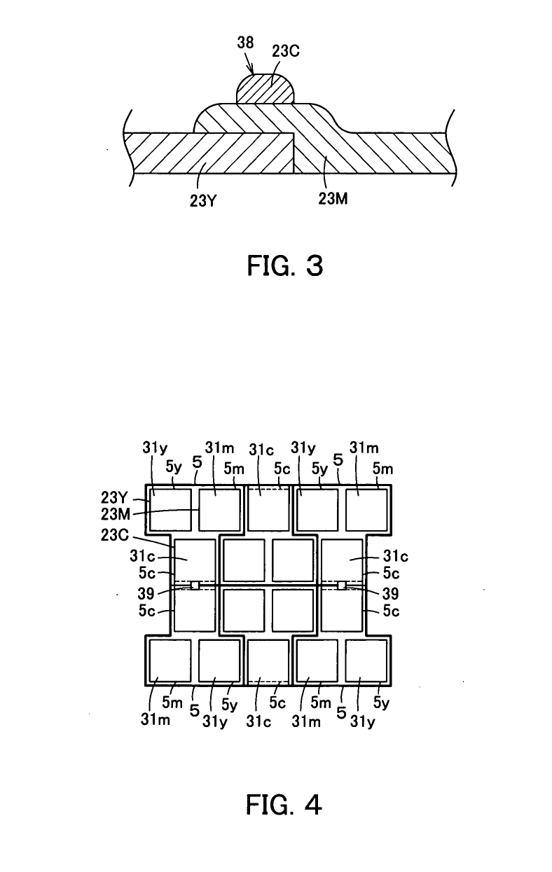

Next, a second embodiment will be described with reference to FIG. 3. The same construction and operation as the first embodiment are represented by the same reference numerals, and description thereof is omitted.

According to the second embodiment, in place of the spacers 27 of the first embodiment, the respective parts of the island-shaped portions 31c, 31m, and 31y of the colored layers 23C, 23M, and 23Y constituting the color filter layer 23 are superimposed over one another to form the spacers 38.

In this embodiment, for example, a part of the island-shaped portion 31m of the colored layer 23M of magenta (M) is superimposed on a part of the island-shaped portion 31y of the colored layer 23Y of Yellow (Y), and further the island-shaped portion 31c of the colored layer 23C of cyan (C) is formed on the upper portion of the superimposed portion of the island-shaped portions 31y and 31m, thereby constructing the spacers 38.

Furthermore, the island-shaped portions 31c of the colored layers 23C having the same color are made continuous with each other over the gap between the adjacent pixels 5 and 5 as in the case of the first embodiment, whereby the same operation and effect as the first embodiment can be achieved. In addition, the colored layers 23C, 23M, and 23Y are superimposed on each other to form the spacers 38, so that the step of forming the spacers 38 is not required to be executed separately from the formation step of the colored layers 23C, 23M, and 23Y, and thus the manufacturing performance is improved.

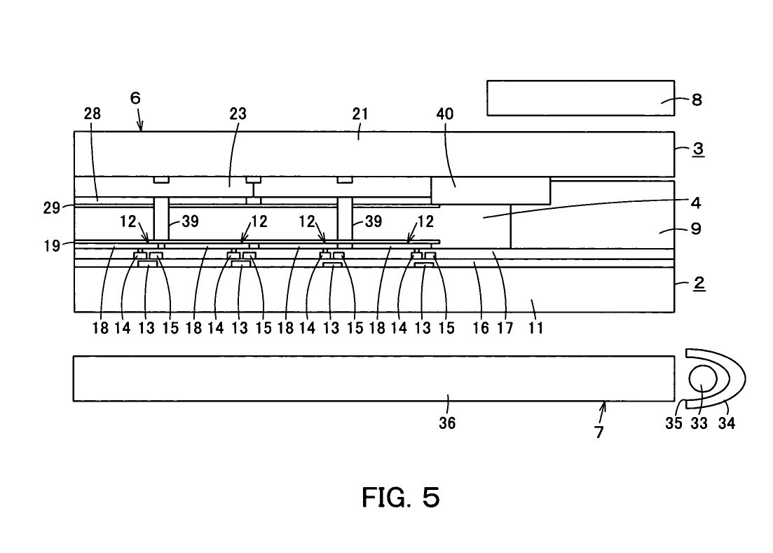

Next, a third embodiment will be described with reference to FIGS. 4 and 5. The same construction and operation as the above embodiments are represented by the same reference numerals, and description thereof is omitted.

According to the third embodiment, in place of the spacer 27 of the first embodiment, as shown in FIG. 5, pillar-shaped spacers 39 are formed from the counter substrate 3 side. As shown in FIG. 4, each spacer 39 is formed at the substantially center position in the width direction on the boundary between the pixels 5 and 5 of the island-shaped portions 31c of the colored layers 23C continuous over the gap between the pixels 5 and 5.

The spacers 39 are formed as follows, for example. After the common electrode 28 is formed, black resin in which black pigment is added to photosensitive acrylic transparent resin is coated at a given thickness as a material having light shielding property on the glass substrate 21 by using a spinner (not shown), and dried. Thereafter, the result is exposed to light by using a photomask (not shown), subsequently developed and baked, whereby the spacers 39 are formed at a film thickness of 5.0 μm. At this time, the peripheral light shielding layer 40 and the black matrix (not shown) are also formed at the counter substrate 3 side at the same time.

This embodiment has the same construction as the first embodiment that the island-shaped portions 31c of the colored layers 23C having the same color are made continuous with each other over the gap between the adjacent pixels 5 and 5, and thus has the same operation and effect as the first embodiment.

Furthermore, the spacer 39 is provided on the boundary of the pixels 5 and 5 of the island-shaped portions 31c of the colored layers 23C continuous over the gap between the adjacent pixels 5 and 5, and thus the spacer 39 does not narrow the light effective area at each of the sub pixels 5c, 5m, and 5y. Therefore, the spacer 39 does not affect the aperture rate and the effect of the step between the colored layers of different colors does not occur in the spacer 39 as compared with the case where the spacers are formed at the boundary between the island-shaped portions of the colored layers of different colors, and thus the spacers 39 can be formed with high precision.

As a result, the gap between the array substrate 2 and the counter substrate 3 of the active matrix substrate 6, that is, the spacing therebetween is made uniform, so that the image reproducibility can be enhanced.

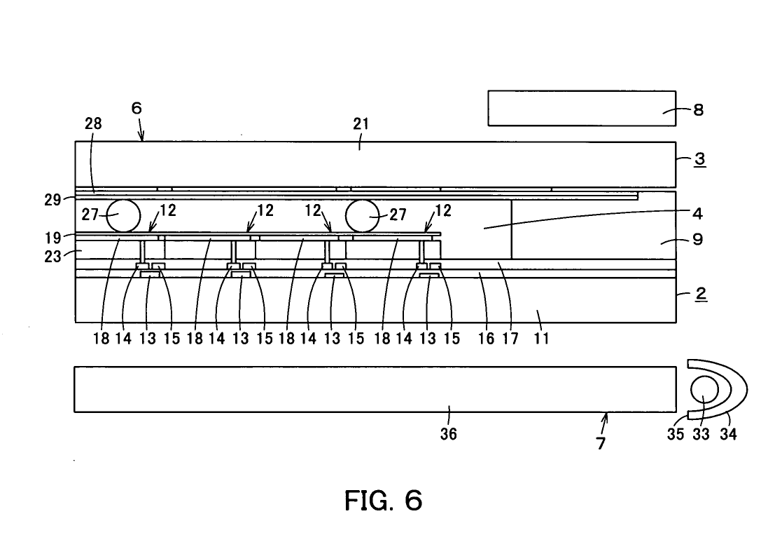

Next, a fourth embodiment will be described with reference to FIG. 6. The same construction and operation as the respective embodiments described above are represented by the same reference numerals, and description thereof is omitted.

According to the fourth embodiment, in the first embodiment, the color filter layer 23 is formed at the array substrate 2 side.

That is, in the array substrate 2, the plurality of thin film transistors 12, the gate lines G and the signal lines S are formed on the glass substrate 11, and the insulating protecting film, the color filter layer 23 having the colored layers 23C and 23M and 23Y, the pixel electrode 18 and the orientation film 19 are successively laminated on the thin film transistors 12 and the wires.

In the counter substrate 3, the black matrix and the peripheral light shielding layer, the common electrode 28 and the orientation film 29 are successively laminated on the glass substrate 21, and the spacers 27 are formed between the orientation films 29 and 19.

For example, when the colored layer 23Y is formed, ultraviolet curable type acrylic resin resist dispersed with yellow pigment is coated on the whole surface by a spinner (not shown), irradiated with ultraviolet rays of 100 mJ/cm² and 365 nm in wavelength through a photomask (not show) through which light is irradiated to a portion at which the colored layer 23Y is desired to be formed, and then developed for 50 seconds with a water solution of tetramethyl ammonium hydroxide (Tetra Methyl Ammonium Hydroxide, TMAH). By repeating the same process, the colored layers 23C and 23M are formed, and the colored layers are baked at 230° C. for one hour, thereby forming the colored layers of 3.0 μm in thickness. At this time, desired through holes are formed at the same time. The other manufacturing process is the same as the first embodiment.

As a result, the island-shaped portions 31c of colored layers 23C having the same color are made continuous over the gap between the adjacent pixels 5 and 5 having the same construction as in the case of the first embodiment, whereby the same operation and effect as the first embodiment can be achieved.

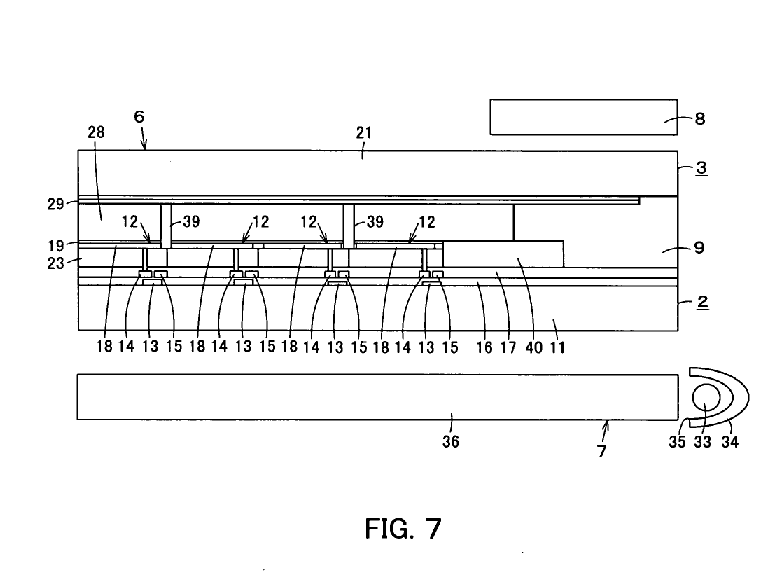

Next, a fifth embodiment will be described with reference to FIG. 7. The same construction and operation as the above embodiments are represented by the same reference numerals and description thereof is omitted.

According to the fifth embodiment, in place of the spacers 27, pillar-shaped spacers 39 are formed from the array substrate 2 side in the fourth embodiment.

The spacers 39 are formed as follows, for example. After the pixel electrode 16 is formed, black resin in which black pigment is added to photosensitive acrylic transparent resin is coated at a given thickness as a material having light shielding property on the glass substrate 11 by using a spinner (not shown), dried, exposed to light by using a photomask (not shown), subsequently developed and baked, thereby forming the spacers 39 at a film thickness of 5.0 μm. At this time, the peripheral light shielding layer 40 and the black matrix (not shown) are formed at the array substrate 2 side at the same time. The other manufacturing process is the same as the fourth embodiment.

This embodiment has the same construction as the first embodiment that the island-shaped portions 31c of the colored layers 23C having the same color are continuous with each other over the gap between the adjacent pixels 5 and 5, and thus has the same operation and effect as the first embodiment.

In the respective embodiments, the colored layers correspond to cyan (C), magenta (M) and yellow (Y). However, the same operation and effect can be achieved by making the colored layers correspond to red (R), green (G) and blue (B).

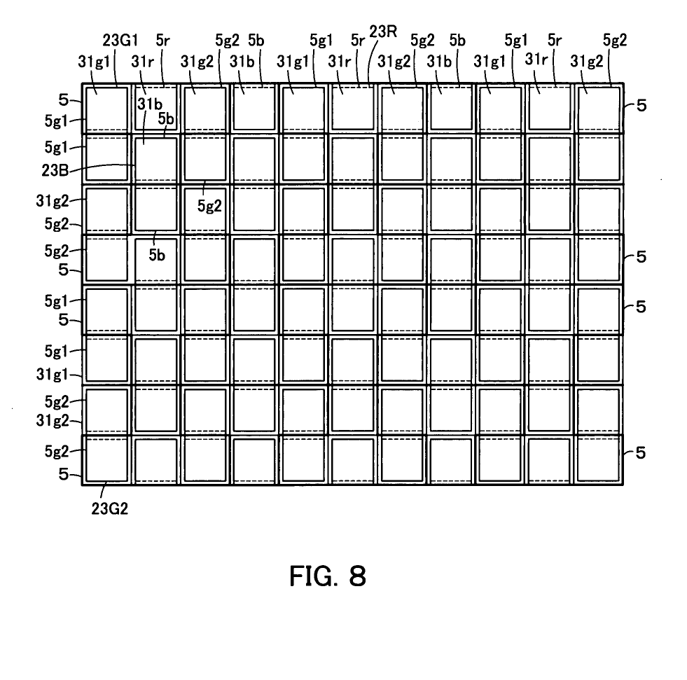

Next, a sixth embodiment will be described with reference to FIG. 8. The same construction and operation as the above embodiments are represented by the same reference numerals, and description thereof is omitted.

According to the sixth embodiment, in the first embodiment or the second embodiment, the pixel 5 includes sub pixels 5r, 5g1, 5g2, and 5b corresponding to four colors of red (R), green (G1), green (G2) different from the above green (G1) and blue (B), and the color filter layer 23 is constructed by colored layers 23R, 23G1, 23G2, and 23B corresponding to these colors.

The two different green colors are two kinds of green color which are different in Munsell hue, Munsell color saturation or the like.

The pixel 5 is constructed by sub pixels 5r, 5g1, 5g2, and 5b disposed in the delta arrangement and designed in a convex shape. The sub pixel 5b is located at the top portion, and the sub pixels 5g1, and 5g2, and 5b are located at the base portion so as to be adjacent to one another in the right-and-left direction. The adjacent pixels 5 in the right-and-left direction and in the up-and-down direction of FIG. 8 are arranged with no gap in a state that they are rotated by 180°, that is, they are reversed in the up-and-down direction and the right-and-left direction. Therefore, the sub pixels 5r, 5g1, 5g2, and 5b are adjacent to the sub pixels 5r, 5g1, 5g2, and 5b of the same color of the adjacent pixel 5 in the up-and-down direction.

Furthermore, the colored layers 23R, 23G1, 23G2, and 23B are constructed by island-shaped portions 31r, 31g1, 31g2 and 31b respectively, and these island-shaped portions 31r, 31g1, 31g2 and 31b are designed in a rectangular shape and continuous with one another over the respective gaps between the sub pixels 5r, 5g1, 5g2, 5b of the same color of the adjacent pixels 5 in the up-and-down direction.

By making the island-shaped portions 31r, 31g1, 31g2 and 31b of the colored layers 23R, 23G1, 23G2, and 23B of the same color continuous with one another over the gaps between the adjacent pixels 5 and 5, the areas of the island-shaped portions 31r, 31g1, 31g2 and 31b can be secured, and the peeling of the island-shaped portions 31r, 31g1, 31g2 and 31b at the time of formation of the color filter layer 23 which occurs in connection with the miniaturization of the island-shaped portions 31r, 31g1, 31g2 and 31b can be suppressed, so that the yield can be improved while enhancing the display quality.

Furthermore, the color layers are constructed by four colors of the red colored layer 23R, the two different kinds of green colored layers 23G1 and 23G2 and the blue colored layer 23B, and thus the color reproducibility can be enhanced as compared with the case where the colored layers are constructed by three colors.

Next, a seventh embodiment will be described with reference to FIG. 9. The same construction and operation as the above embodiments are represented by the same reference numerals, and description thereof is omitted.

According to the seventh embodiment, the sixth embodiment adopts a so-called mosaic arrangement in which the island-shaped portions 31r, 31g1, 31g2 and 31b of the colored layers 23R, 23G1, 23G2, and 23B are designed in a right-angled triangular shape, and they are arranged at the respective sides of the rectangular pixel 5 so that the right-angled apex of each triangle of respective portions 31r, 31g1, 31g2, and 31b faces the center portion of the pixel 5.

That is, the pixels 5 are arranged so that the sub pixels 5r, 5g1, 5g2, and 5b of the same color are disposed with no gap therebetween so as to be adjacent to one another between the pixels 5 and 5 in a state that the pixels 5 which are adjacent to each other in the right-and-left direction and in the up-and-down direction of FIG. 9 are mutually rotated by 180°, that is, reversed in the up-and-down direction and the right-and-left direction. For example, in this embodiment, each pixel 5 is disposed so that the sub pixels 5r, 5g1, 5g2, and 5b are successively disposed in the clockwise direction of FIG. 9.

Furthermore, the pixels 5 are arranged so that the respective sides thereof correspond to the right-and-left direction and the up-and-down direction shown in FIG. 9.

Furthermore, the island-shaped portions 31r, 31g1, 31g2 and 31b are formed so as to be continuous with one another over the gaps between the sub pixels 5r, 5g1, 5g2, and 5b of the same color of the adjacent pixels 5 and 5. That is, in this embodiment, the island-shaped portions 31r and 31g2 are continuous between the pixels 5 and 5 adjacent to each other in the up-and-down direction, and the island-shaped portions 31g1 and 31b are continuous between the pixels 5 and 5 adjacent to each other in the right-and-left direction.

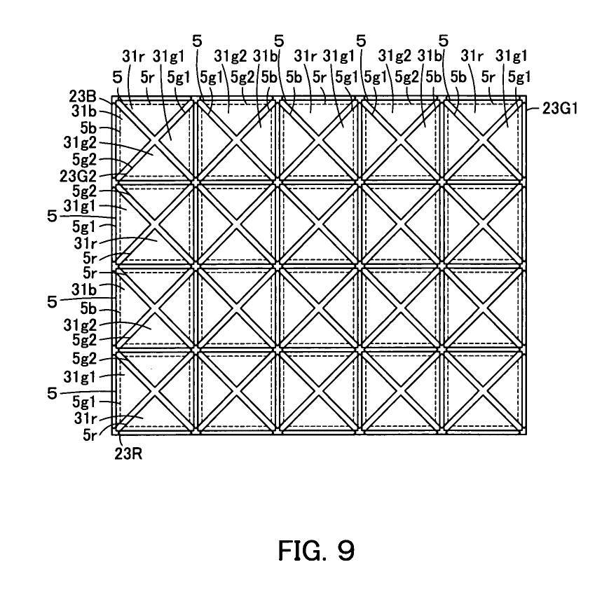

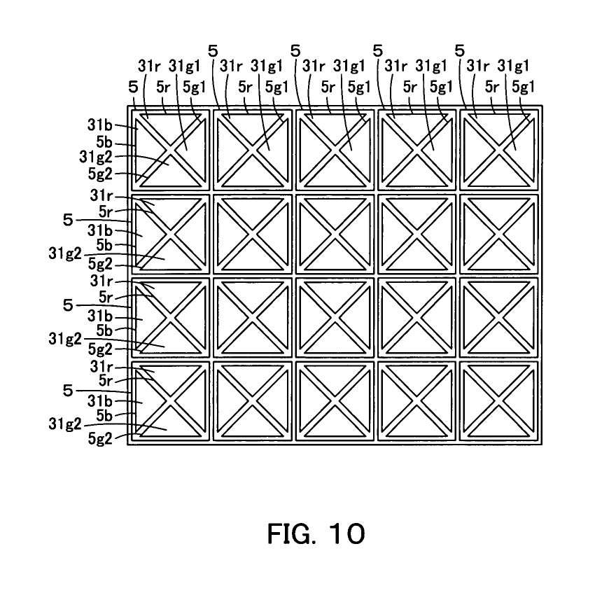

The island-shaped portions 31r of the colored layers 23R of the same color, the island-shaped portions 31g1 of the colored layers 23G1, the island-shaped portions 31g2 of the colored layers 23G2 and the island-shaped portions 31b of the colored layers 23B are made continuous with each other between the adjacent pixels 5 and 5, for example, as the conventional example shown in FIG. 10, whereby the peeling of the island-shaped portions 31r, 31g1, 31g2 and 31b at the time of formation of the color filter layer 23 which occurs in connection with the miniaturization of the island-shaped portions 31r, 31g1, 31g2 and 31b can be suppressed unlike the case where all the island-shaped portions 31r, 31g1, 31g2 and 31b are formed separately from one another without being continuous, so that the yield can be improved while enhancing the display quality.

Furthermore, by disposing the respective sub pixels 5r, 5g1, 5g2, and 5b in the mosaic arrangement, the fineness can be further improved and the image reproducibility can be further enhanced as compared with the case where the sub pixels (colored layers) are designed in a rectangular shape.

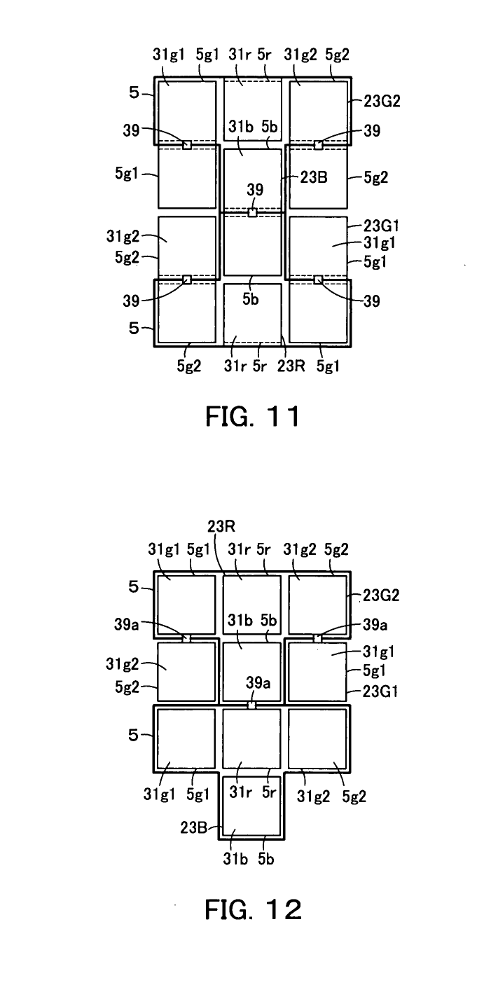

Next, an eighth embodiment will be described with reference to FIG. 11. The same construction and operation as the third embodiment are represented by the same reference numerals, and description thereof is omitted.

According to the eighth embodiment, in the third embodiment, as in the case of the sixth embodiment, the pixel 5 is constructed by the sub pixels 5r, 5g1, 5g2, and 5b of four colors of red (R), green (G1), green (G2) and blue (B), and the color filter layer 23 is constructed by the colored layers 23R, 23G1, 23G2, and 23B corresponding to these colors.

That is, the respective island-shaped portions 31r, 31g1, 31g2 and 31b are formed so as to be continuous with the island-shaped portions 31r, 31g1, 31g2 and 31b of the same colors over the gap between the pixels 5 and 5 adjacent to each other in the up-and-down direction.

Furthermore, the spacers 39 are disposed on the boundary (not shown) between the pixels 5 and 5 of the adjacent island-shaped portions 31r, on the boundary between the pixels 5 and 5 of the island-shaped portions 31g1, on the boundary between the pixels 5 and 5 of the island-shaped portions 31g2 and on the boundary between the pixels 5 and 5 of the island-shaped portions 31b, respectively.

By making the island-shaped portions 31c of the colored layers 23C of the same color continuous with each other over the gap between the adjacent pixels 5 and 5, the same operation and effect as the first embodiment can be achieved. In addition, by disposing the spacers 39 on the boundary between the pixels 5 and 5 of the island-shaped portions 31r of the colored layers 23R of the same color, on the boundary between the pixels 5 and 5 of the island-shaped portions 31g1 of the colored layers 23G1 of the same color, on the boundary between the pixels 5 and 5 of the island-shaped portions 31g2 of the colored layer 23G2 of the same color and on the boundary between the pixels 5 and 5 of the island-shaped portions 31b of the colored layers 23B of the same color, for example, as the conventional example shown in FIG. 12, the effect of the colored layers of different colors does not occur in the spacers 39 and thus the spacers 39 can be formed with higher precision unlike the case where the spacers 39a are disposed between the sub pixels 5g1 and 5g2 of the colored layers of different colors or between the sub pixels 5r and 5b as in the case of the conventional art. Therefore, the spacing between the array substrate 2 and the counter substrate 3 of the active matrix substrate 6 can be made uniform, and thus the image reproducibility can be enhanced.

Furthermore, the colored layers are constructed by four colors of the red colored layer 23R, the two different kinds of green colored layers 23G1 and 23G2 and the blue colored layer 23B, whereby the color reproducibility can be further enhanced as compared with the case where the colored layers are constructed by three colors.

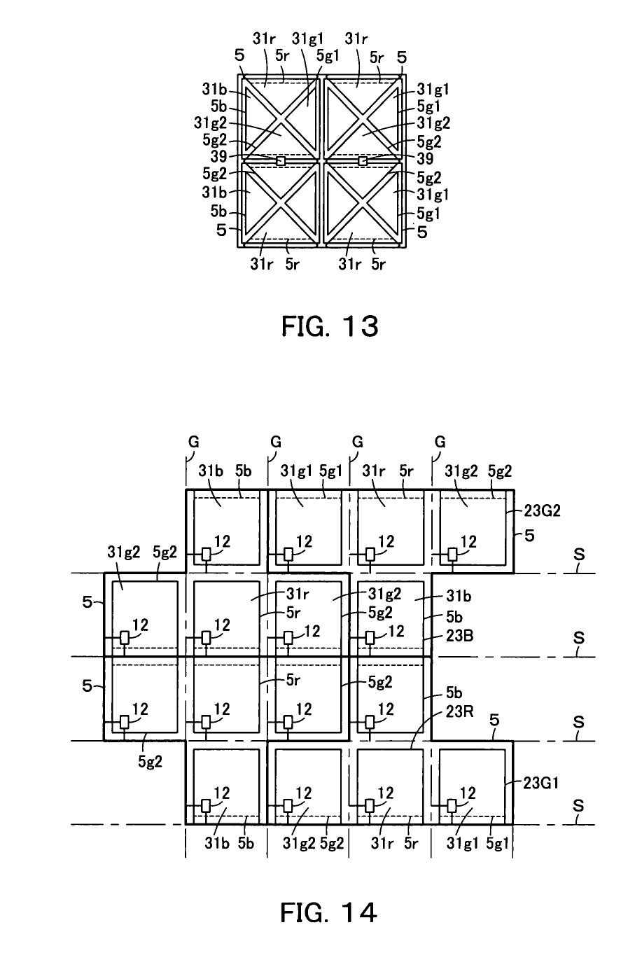

Next, a ninth embodiment will be described with reference to FIG. 13. The same construction and operation as the above embodiments are represented by the same reference numerals, and description thereof is omitted.

According to the ninth embodiment, in the third embodiment, the pixel 5 is constructed by sub pixels 5r, 5g1, 5g2, and 5b corresponding to four colors of red (R), green (G1), green (G2) and blue (B), the color filter layer 23 is constructed by the colored layers 23R, 23G1, 23G2 and 23B, and the mosaic arrangement is adopted.

That is, the pixels 5 are arranged with no gap so that the sub pixels 5r and 5r of the same color and the sub pixels 5g2 and 5g2 are adjacent to each other between the adjacent pixels 5 and 5 in the up-and-down direction in a state that the pixels 5 adjacent to each other in the up-and-down direction of FIG. 13 are mutually rotated by 180°, that is, they are reversed in the up-and-down direction and the right-and-left direction. For example, in this embodiment, the sub pixels 5r, 5g1, 5g2, and 5b are successively arranged in the clockwise direction of FIG. 13 in each pixel 5.

Furthermore, the pixels 5 are arranged so that the respective sides thereof correspond to the right-and-left direction and the up-and-down direction shown in FIG. 9.

The island-shaped portions 31r of the colored layers 23R of the same color, and the island-shaped portions 31g2 of the colored layers 23G2 are continuous with each other over the gap between the adjacent pixels 5 and 5, whereby the areas of the island-shaped portions 31r and 31g2 can be secured, and the peeling of the island-shaped portions 31r and 31g2 at the time of formation of the color filter layer 23 which occurs in connection with the miniaturization of the island-shaped portions 31r and 31g2 can be suppressed, so that the yield can be improved while enhancing the display quality.

By disposing the spacer 39 on the boundary between the pixels 5 and 5 of the island-shaped portions 31g2 of the colored layers 23G2 of the same color, the effect of the step between the colored layers of different colors does not occur in the spacer 39. Therefore, the spacers 39 can be formed with high precision, and the interval between the array substrate 2 and the counter substrate 3 of the active matrix substrate 6 is made uniform, and thus the image reproducibility can be enhanced.

Furthermore, the colored layers are constructed by four colors of the red colored layer 23R, the two different kinds of green colored layers 23G1 and 23G2 and the blue colored layer 23B, whereby the color reproducibility can be enhanced as compared with the case where the colored layers are constructed by three colors.

Still furthermore, by disposing the respective sub pixels 5r, 5g1, 5g2, and 5b in the mosaic arrangement, fineness can be further improved and the image reproducibility can be further enhanced as compared with, for example, the case where the sub pixels (colored layers) are designed in a rectangular shape.

Next, a tenth embodiment will be described with reference to FIG. 14. The same construction and operation as the above embodiments are represented by the same reference numerals, and description thereof is omitted.

According to the tenth embodiment, in the fourth embodiment and the fifth embodiment, as in the case of the sixth embodiment, the pixel 5 is constructed by the sub pixels 5r, 5g1, 5g2, and 5b corresponding to four colors of red (R), green (G1), green (G2) different from the green (G1) and blue (B), and the color filter layer 23 is constructed by the colored layers 23R, 23G1, 23G2, and 23B corresponding to these colors. That is, the colored layers 23R, 23G1, 23G2 and 23B are formed at the array substrate 2 side.

Even in the case of the above construction, the same operation and effect as the fourth embodiment and the fifth embodiment can be achieved. In addition, the colored layers are constructed by the red colored layer 23R, the two different kinds of green colored layers 23G1 and 23G2 and the blue colored layer 23B, whereby the color reproducibility can be further enhanced as compared with the colored layers are constructed by three colors.

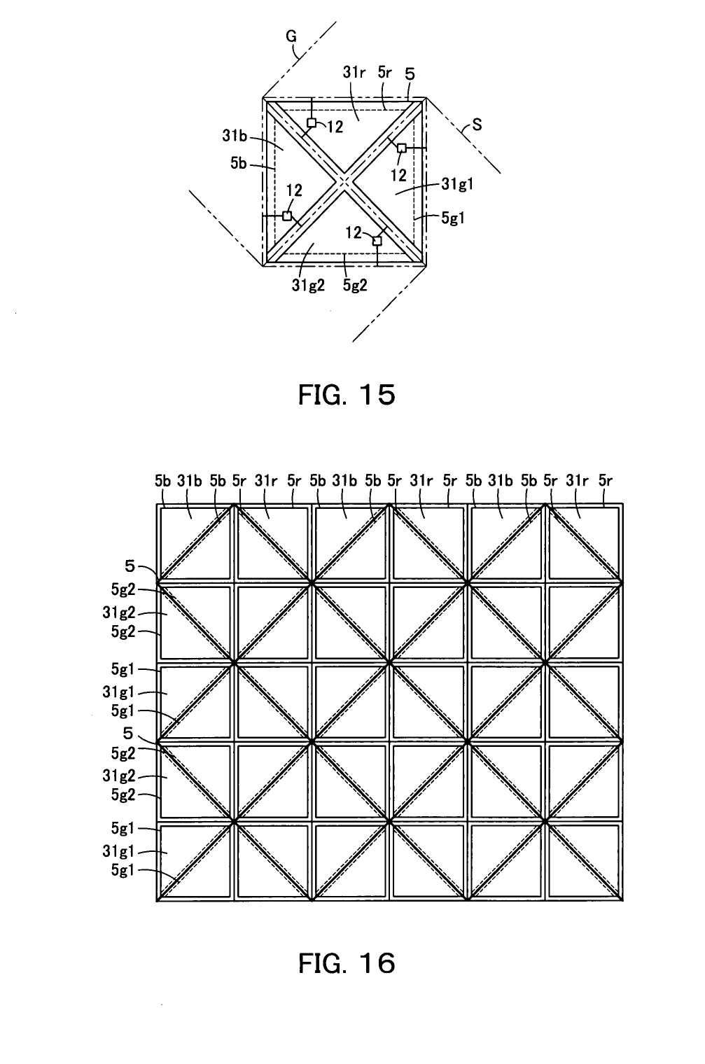

Next, an eleventh embodiment will be described with reference to FIGS. 15 and 16. The same construction and operation as the above embodiments are represented by the same reference numerals, and description thereof is omitted.

According to the eleventh embodiment, in the tenth embodiment, as in the case of the seventh embodiment, the pixels 5 are designed so that the island-shaped portions 31r, 31g1, 31g2 and 31b of the colored layers 23R, 23G1, 23G2, and 23B are disposed in the mosaic arrangement as shown in FIG. 15.

Furthermore, as shown in FIG. 16, the pixels 5 are arranged so that the respective apexes are continuous with one another in the right-and-left direction and the up-and-down direction. That is, in this embodiment, the island-shaped portion 31r of the colored layer 23R is continuous with the island-shaped portion 31r of the pixel 5 at the upper right side shown in FIG. 16, the island-shaped portion 31g1 of the colored layer 23G1 is continuous with the island-shaped portion 31g1 of the pixel 5 at the lower right side shown in FIG. 16, the island-shaped portion 31g2 of the colored layer 23G2 is continuous with the island-shaped portion 31r of the pixel 5 at the lower left side shown in FIG. 16, and the island-shaped portion 31b of the colored layer 23B is continuous with the island-shaped portion 31b of the pixel 5 at the upper left side shown in FIG. 16.

Even in the case of the above construction, the same operation and effect as the tenth embodiment can be achieved. By disposing the respective sub pixels 5r, 5g1, 5g2, and 5b in the mosaic arrangement, fineness can be further improved and the image reproducibility can be further enhanced as compared with the case where the sub pixels (colored layers) are designed in a rectangular shape or the like.

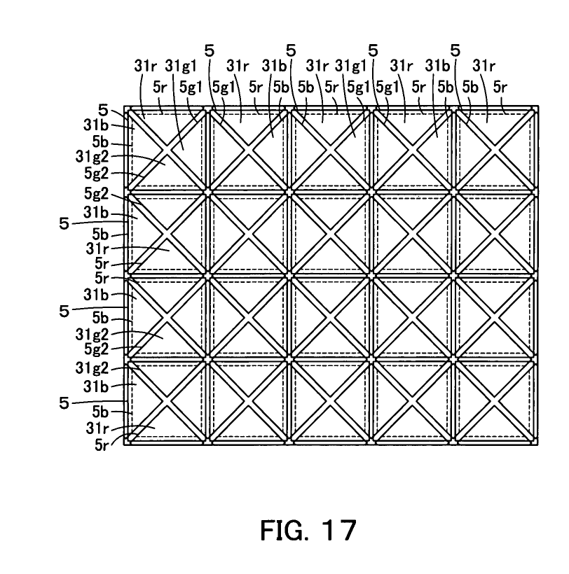

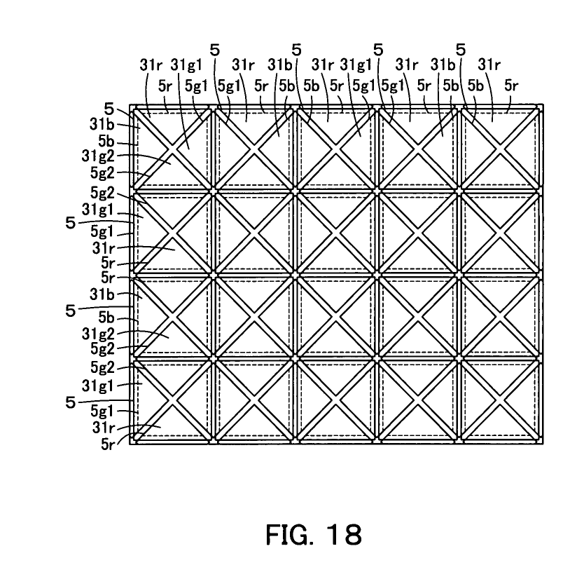

In the seventh embodiment, the ninth embodiment and the eleventh embodiment, the same operation and effect can be achieved by the construction that the pixels 5 reversed in the right-and-left direction are juxtaposed with one another in the right-and-left direction and also the pixels 5 reversed in the up-and-down direction are juxtaposed with one another in the up-and-down direction as in the case of a twelfth embodiment shown in FIG. 17, or the construction that the pixels 5 reversed in the right-and-left direction are juxtaposed with one another in the right-and-left direction and also the pixels 5 reversed in the up-and-down direction and the right-and-left direction are juxtaposed with one another in the up-and-down direction as in the case of a thirteenth embodiment shown in FIG. 18, and further the construction that the pixels 5 reversed in the up-and-down and right-and-left directions are juxtaposed with one another in the right-and-left direction and also the pixels 5 reversed in the up-and-down direction are juxtaposed with one another in the up-and-down direction (not shown).

Furthermore, in the above embodiments, the thin film transistors 12 may be designed in various styles such as a top gate type, bottom gate type, etc.

What is claimed is:

1. A liquid crystal display element comprising an array substrate, a counter substrate disposed so as to face the array substrate, and a liquid crystal layer interposed between the array substrate and the counter substrate, pixels each of which has a plurality of sub pixels corresponding to plural kinds of different colors are formed in a matrix form, wherein each sub pixel has a colored layer provided between the array substrate and the counter substrate corresponding to each color, the respective colored layers are formed in an island-shape and at least some of the colored layers are continuous with one another over the gap between the adjacent pixels.

2. The liquid crystal display element according to claim 1, further comprising a spacer that is disposed at the boundary between the pixels of the colored layers continuous with each other over the gap between the adjacent pixels and keeps the spacing between the array substrate and the counter substrate.

3. The liquid crystal display element according to claim 1, wherein the colored layers comprise four kinds of colored layers corresponding to red color, blue color and two different green colors.
